(19) United States
(12) Patent Application Publication
(10) Pub. No.: US 2026/0086501 A1
(43) Pub. Date: Mar. 26, 2026

(54) CORRECTION OF GHOST ARTIFACTS IN EXTENDED REALITY SYSTEMS

(71) Applicant: Microsoft Technology Licensing, LLC, Redmond, WA (US)

(72) Inventors: Michaela PORUBANOVA, Seattle, WA (US); Katri Maria OLKKONEN SAARELA, Helsinki (FI)

(21) Appl. No.: 18/893,504

(22) Filed: Sep. 23, 2024

(51) Int. Cl. G03H 1/04; G03H 1/22; G06T 19/00; G06V 10/56; G06V 10/60

(52) U.S. Cl. CPC G03H 1/0486; G03H 1/22; G06T 19/006; G06V 10/56; G06V 10/60

(57) ABSTRACT

A service corrects a ghost artifact of a hologram displayed by an ER system. The ghost artifact occurs as a result of display light for the hologram back-reflecting off of optical elements. The service obtains an image of a scene in which the ER system is operating. The service determines a location, within the display's FOV, where the ghost artifact is displayed or is likely to be displayed. The service determines a contrast between the ghost artifact and an overlapping region of the image. The service determines that the contrast exceeds a ghost visibility threshold. The service then reduces the luminance of the hologram, resulting in the contrast between the ghost artifact and the overlapping region of the image falling below the ghost visibility threshold and resulting in the ghost artifact merging with the scene.

### BACKGROUND

Head mounted devices (HMDs), or other wearable devices, are becoming highly popular. These types of devices are able to provide a so-called “extended reality” experience.

The phrase “extended reality” (ER) is an umbrella term that collectively describes various different types of immersive platforms. Such immersive platforms include virtual reality (VR) platforms, mixed reality (MR) platforms, and augmented reality (AR) platforms. The ER system provides a “scene” to a user. As used herein, the term “scene” generally refers to any simulated environment (e.g., three-dimensional (3D) or two-dimensional (2D)) that is displayed by an ER system.

For reference, conventional VR systems create completely immersive experiences by restricting their users' views to only virtual environments. This is often achieved through the use of an HMD that completely blocks any view of the real world. Conventional AR systems create an augmented-reality experience by visually presenting virtual objects that are placed in the real world. Conventional MR systems also create an augmented-reality experience by visually presenting virtual objects that are placed in the real world, and those virtual objects are typically able to be interacted with by the user. Furthermore, virtual objects in the context of MR systems can also interact with real world objects. AR and MR platforms can also be implemented using an HMD. ER systems can also be implemented using laptops, handheld devices, HMDs, and other computing systems.

Unless stated otherwise, the descriptions herein apply equally to all types of ER systems, which include MR systems, VR systems, AR systems, and/or any other similar system capable of displaying virtual content. An ER system can be used to display various different types of information to a user. Some of that information is displayed in the form of a “hologram.” As used herein, the term “hologram” generally refers to image content that is displayed by an ER system. In some instances, the hologram can have the appearance of being a 3D object while in other instances the hologram can have the appearance of being a 2D object. In some instances, a hologram can also be implemented in the form of an image displayed to a user.

Continued advances in hardware capabilities and rendering technologies have greatly increased the realism of holograms and scenes displayed to a user within an ER environment. For example, in ER environments, a hologram can be placed within the real world in such a way as to give the impression that the hologram is part of the real world. As a user moves around within the real world, the ER environment automatically updates so that the user is provided with the proper perspective and view of the hologram. This ER environment is the “scene” mentioned previously.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for correcting a ghost artifact of a hologram that is displayed by an extended reality (ER) system, where the ghost artifact of the hologram occurs as a result of display light for the hologram back-reflecting off of one or more optical elements of the ER system, resulting in generation of the ghost artifact, and where the ghost artifact has a faded luminance relative to a luminance of the hologram, said method including: obtaining an image of a scene in which the ER system is operating, wherein a region of the image portrays at least some of a field of view (FOV) of a display of the ER system; determining a location, within the display's FOV, where the ghost artifact is displayed or is likely to be displayed; determining a contrast between the ghost artifact and an overlapping region of the image where the ghost artifact would overlap the image based on an alignment between (i) the image and (ii) the location in the display's FOV where the ghost artifact is displayed or is likely to be displayed; determining that the contrast exceeds a ghost visibility threshold; and reducing the luminance of the hologram, resulting in the contrast between the ghost artifact and the overlapping region of the image falling below the ghost visibility threshold and further resulting in the ghost artifact substantially visually merging with the scene.

In some aspects, the techniques described herein relate to a computer system that corrects a ghost artifact of a hologram that is displayed by the computer system, where the ghost artifact of the hologram occurs as a result of display light for the hologram back-reflecting off of one or more optical elements of the computer system, resulting in generation of the ghost artifact, and where the ghost artifact has a faded luminance relative to a luminance of the hologram, said computer system including: a processor system; and a storage system that stores instructions that are executable by the processor system to cause the computer system to: obtain an image of a scene in which the computer system is operating, wherein a region of the image portrays at least some of a field of view (FOV) of a display of the computer system; determine a location, within the display's FOV, where the ghost artifact is displayed or is likely to be displayed; determine a contrast between the ghost artifact and an overlapping region of the image where the ghost artifact would overlap the image based on an alignment between (i) the image and (ii) the location in the display's FOV where the ghost artifact is displayed or is likely to be displayed; determine that the contrast exceeds a ghost visibility threshold; and reduce the luminance of the hologram, resulting in the contrast between the ghost artifact and the overlapping region of the image falling below the ghost visibility threshold and further resulting in the ghost artifact substantially visually merging with the scene.

In some aspects, the techniques described herein relate to an extended reality (ER) system that corrects a ghost artifact of a hologram that is displayed by the ER system, where the ghost artifact of the hologram occurs as a result of display light for the hologram back-reflecting off of one or more optical elements of the ER system, resulting in generation of the ghost artifact, and where the ghost artifact has a faded luminance relative to a luminance of the hologram, said ER system including: a processor system; and a storage system that stores instructions that are executable by the processor system to cause the ER system to: obtain an image of a scene in which the ER system is operating, wherein a region of the image portrays at least some of a field of view (FOV) of a display of the ER system; determine a location, within the display's FOV, where the ghost artifact is displayed or is likely to be displayed; determine a contrast between the ghost artifact and an overlapping region of the image where the ghost artifact would overlap the image based on an alignment between (i) the image and (ii) the location in the display's FOV where the ghost artifact is displayed or is likely to be displayed; determine that the contrast exceeds a ghost visibility threshold; and reduce the luminance of the hologram, resulting in the contrast between the ghost artifact and the overlapping region of the image falling below the ghost visibility threshold and further resulting in the ghost artifact substantially visually merging with the scene.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computer architecture configured to correct for a ghosting effect.

FIG. 2 illustrates an example HMD.

FIG. 3 illustrates a scenario in which the HMD's cameras are capturing an image of a scene.

FIG. 4 illustrates an example of a ghost artifact.

FIG. 5 illustrates another example of a ghost artifact.

FIG. 6 illustrates characteristics of a hologram and a scene image.

FIG. 7 illustrates a contrast between a ghost artifact and the background of a scene.

FIG. 8 illustrates a scenario in which reductions to a hologram's luminance effectively merge a ghost artifact with the scene's background.

FIG. 9 illustrates a flowchart of an example method for correcting ghost artifacts.

FIG. 10 illustrates an example computer system that can be configured to perform any of the disclosed operations.

### DETAILED DESCRIPTION

The adoption of ER devices has been somewhat stymied due to a combination of issues involving image quality and user visual discomfort. One example of a problem with image quality is a so-called “ghosting” effect. Ghosting in ER systems is a significant issue that impacts the visual quality of the ER experience.

Ghosting occurs when display light reflects from one optical element in the ER system, propagates back to the ER system's display panel, reflects again off the ER system's panel, and then couples back to the original optical element. These reflections create a weaker, faded, or subdued copy of the original image, and the copy is displayed in a different part of the display's field of view. The visual perception of this ghost artifacts degrades the overall quality of the scene.

The perceptibility of ghosting can be measured in a manner similar to crosstalk in stereoscopic images, where the incomplete isolation of left and right image channels cause one image to leak into the other. With ER systems, this is referred to as “perceived image crosstalk.”

Ghosting matters because it can be a significant detriment to visual quality, and it can impact the user's comfort and experience with ER technology. High contrast stimuli (i.e. holograms), which are often present in ER scenes to improve the perceptibility of the digital content, often suffer from ghosting. Additionally, ghosting can cause increased eye strain on the part of the user. Addressing ghosting is thus highly desirable to ensure a comfortable and immersive ER experience.

There have been a few techniques that attempt to reduce ghosting in ER systems. For instance, one technique involves polarization of the display. Another technique involves physically titling the display. These techniques have various drawbacks in that they can produce undesirable results.

For instance, polarization typically is effective only for a specific wavelength of light. If the ghost artifact includes other wavelengths of light, then the polarizer will have little-to-no dampening impact on those other colors. Tilting of the display can be effective, but it requires a holistic change in how content is displayed, thereby resulting in significant design modifications.

The disclosed embodiments provide significant benefits, advantages, and practical applications in how holograms are displayed in an ER system. In particular, the embodiments are directed to various techniques that take into account the workings of the human-visual-system. In doing so, the embodiments are able to significantly reduce or even fully eliminate the impact of a ghosting artifact. As a result, the embodiments improve the quality of images (e.g., holograms) displayed by an ER system. The embodiments also improve the user's experience with the ER system by reducing (or eliminating) eye strain, nausea, and even imbalance.

Beneficially, the embodiments employ an algorithm that determines the luminance of a scene's background content. This determination can involve the determination of the scene's color or color combination. The embodiments also rely on a ghost visibility threshold that is designed to accommodate the human visual system. Optionally, if only one color is present (e.g., red or green), the embodiments can use the threshold for that single color. If a multi-color combination is present, the embodiments can apply one or more (or perhaps a lower) threshold (e.g., perhaps red). The embodiments then apply a specific display luminance/brightness for the hologram (which propagates to the ghosting artifact) in order for this threshold not to be exceeded by the ghosting artifact.

By lowering the luminance of the hologram, the luminance of the resulting ghosting artifact is reduced to a point where it effectively merges with the background and becomes hidden in the background. As a result, the ghosting artifact is no longer visible (or is at least not a distraction) to the user. In some scenarios, if the ghost visibility threshold cannot be met, the embodiments can apply a ghost annoyance threshold designed to maintain the quality of the hologram so as to not fall below a quality threshold while also reducing the visibility (and hence distractibility) of the ghosting artifact. In this regard, the disclosed embodiments are directed to techniques that use human visual system-aware ghosting correction mechanisms.

In some scenarios, the ghost annoyance threshold can be implemented as a more relaxed threshold compared to the visibility threshold. By way of example, if the visibility threshold is 0.5%, the annoyance threshold can be set to 0.8%, meaning that at that contrast, the ghost can be seen but it is not yet annoying to the user. This more relaxed threshold can be used instead of the visibility threshold if using the visibility threshold would lead to the hologram luminance to be decreased too much. Thus, the ghost annoyance threshold can be implemented in a variety of ways.

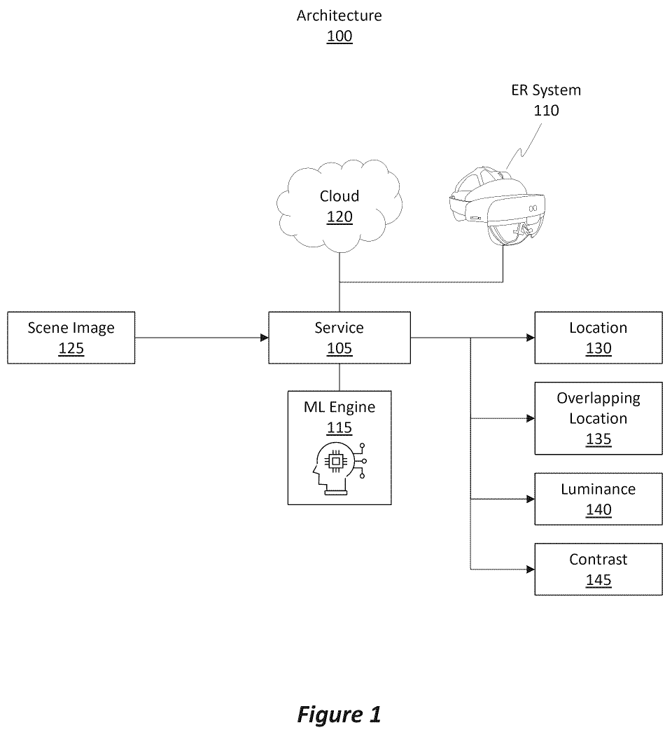

Having just described some of the high level benefits, advantages, and practical applications achieved by the disclosed embodiments, attention will now be directed to FIG. 1, which illustrates an example computing architecture 100 that can be used to achieve those benefits. Architecture 100 includes a service 105, which can be implemented by an ER system 110 comprising an HMD.

As used herein, the phrases ER system, HMD, ER platform, ER device, or wearable device can all be used interchangeably and generally refer to a type of system that displays holographic content (i.e. holograms). In some cases, ER system 110 is of a type that allows a user to see various portions of the real world and that also displays virtualized content in the form of holograms. That ability means ER system 110 is able to provide so-called “passthrough images” to the user. It is typically the case that architecture 100 is implemented on an MR or AR system, though it can also be implemented in a VR system.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 120 environment. In some implementations, service 105 is a local service operating on a local device, such as the ER system 110. In some implementations, service 105 is a hybrid service that includes a cloud component operating in the cloud 120 and a local component operating on a local device. These two components can communicate with one another.

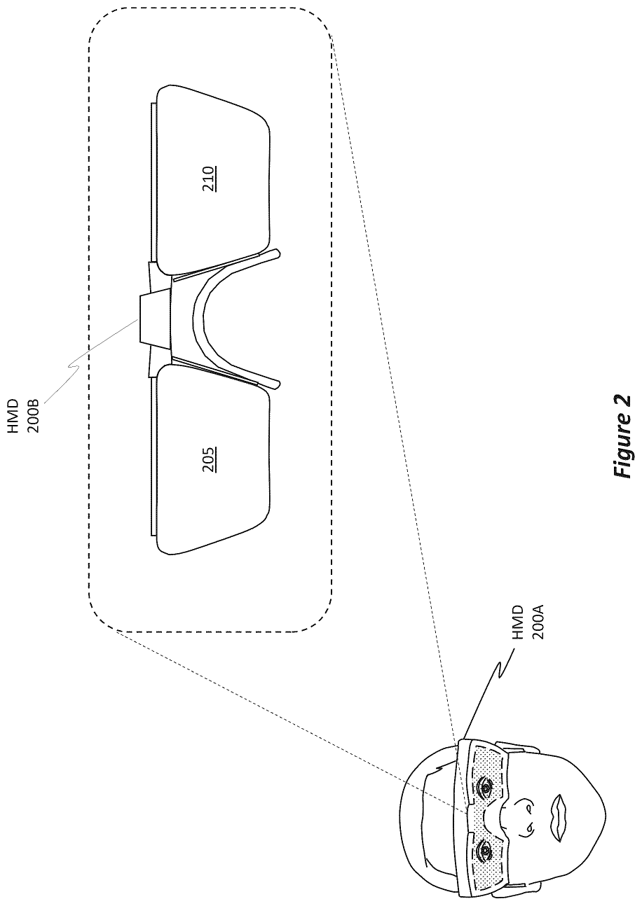

Turning briefly to FIG. 2, HMDs 200A and 200B are shown, where these HMDs are representative of the ER system 110 of FIG. 1. HMD 200B includes a left display 205, which is visible to the user's left eye, and a right display 210, which is visible to the user's right eye. Together, these two displays can provide binocular vision to the user. Thus, by displaying holograms at specific pixel positions relative to one another, HMD 200B can display content in a manner such that the user perceives the content as having depth relative to the user. That is, HMD 200B displays a first image in the left display 205 and a second, different image in the right display 210. The user will view these two separate images, and the user's mind can fuse them, thereby allowing the user to perceive depth with respect to the holograms.

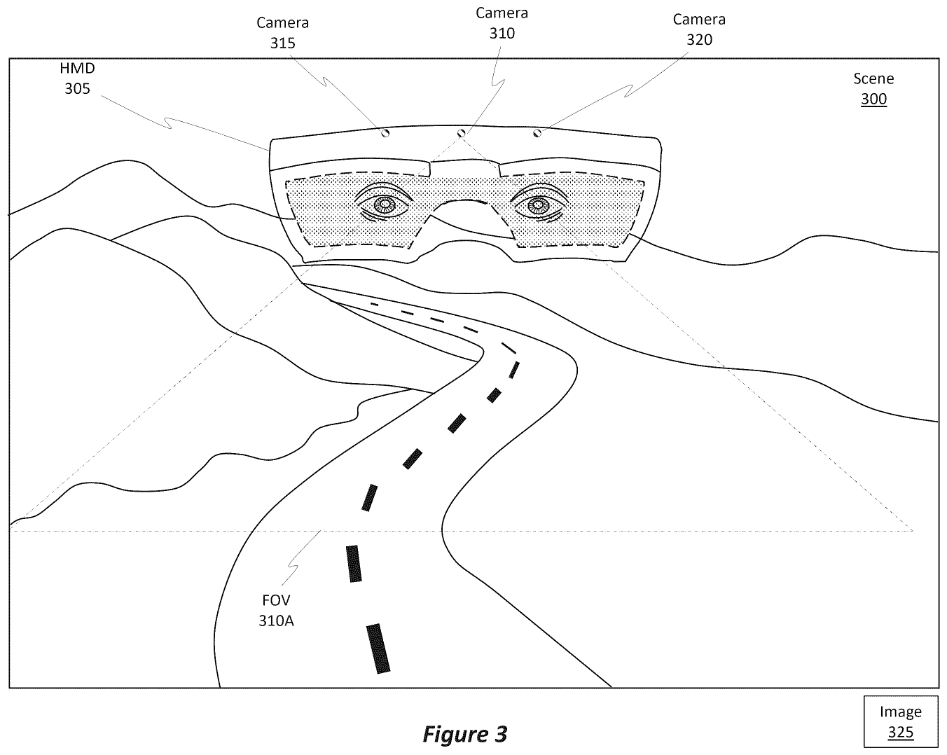

Returning to FIG. 1, service 105 is tasked with obtaining an image of the scene in which the ER system 110 is operating, as shown by scene image 125. FIG. 3 provides an illustration.

FIG. 3 shows a scene 300 in which an HMD 305, which is representative of the HMDs discussed thus far, is operating. In accordance with the disclosed principles, HMD 305 is equipped with one or more outwardly directed cameras, such as camera 310, camera 315, and camera 320. Notice the placement of these different cameras. If only a single camera is used, typically that single camera (e.g., camera 310) will be placed at a central position of the HMD 305, such as a position generally between the left and right displays. This single camera 310 will then be able to capture a single image 325 of the scene 300. Notably, the camera 310's field of view (FOV 310A) is designed to capture at least some, but potentially an entirety, of the FOV's of both the left and right displays.

Additionally, or alternatively, some embodiments provide a dedicated camera to the first display (e.g., see camera 315) and a dedicated camera to the second display (e.g., see camera 320). Camera 315 is configured to capture an entire FOV of the first display. Similarly, camera 320 is configured to capture an entire FOV of the second display. In some scenarios, the cameras are not required to capture an entire FOV of the displays, but they at least capture a majority of those FOVs. Thus, in some scenarios, some, but not necessarily all, of the FOVs of the displays are captured by the cameras 315 and 320 FOVs. If the displays render foveated content, then the FOV of the cameras 315 and 320 is designed to at least capture these foveated regions.

The cameras 310, 315, and 320 can be of any type. For example, the cameras 310, 315, and 320 can be visible light cameras, low light cameras, thermal imaging cameras, ultraviolet light cameras, or any other type of camera. Typically, the cameras 310, 315, and 320 are visible light cameras. Regardless of their type, the cameras 310, 315, and 320 are designed to capture one or more images of the scene 300, as shown by image 325. Thus, the image 325 of FIG. 3 corresponds to the scene image 125 of FIG. 1.

Returning to FIG. 1, service 105 then identifies attributes of the hologram that is either currently being displayed or will subsequently be displayed. These attributes include the display placement location of the hologram, the color attributes of the hologram, and the luminance levels of the hologram. Based on the determined display placement location, service 105 determines or predicts where the ghosting artifact will be displayed in the ER system 110's display. Service 105 is able to make this determination or prediction based on a variety of factors.

In one scenario, service 105 determines the ghosting artifact's display location based on calculations involving the back reflection characteristics of the display. In another scenario, service 105 obtains an image of the display itself, and service 105 identifies the ghost artifact within the image. In another scenario, service 105 predicts the ghosting artifact's display based on historical data of ghosting artifacts and locations of holograms.

By way of example, the embodiments can display a hologram and then capture an image of the ER system's display. This image will reveal the location of the ghosting artifact as well as the location of the hologram. The embodiments can then generate a mapping based on the location of the hologram and the location of the ghosting artifact. Correlations between these different locations and possibly based on the attributes of the hologram can then be recorded and used to determine or predict subsequent locations of ghosting artifacts. If a sufficient amount of mapping data is generated, then accurate predictions can be made for any hologram. In this regard, service 105 is able to determine the location of a ghosting artifact based on the display location of that ghosting artifact's corresponding hologram. The ML engine 115 can be trained in such a manner to make these predictions.

If service 105 determines that the ghosting artifact will not be visible on the display (e.g., it is out of the display's FOV), then service 105 can refrain from performing any further action because the ghosting artifact will not be visible to the user. In some scenarios, if service 105 determines that at least some of the ghosting artifact will be displayed outside of the display's FOV, then service 105 can also refrain from performing subsequent actions. In some scenarios, if a threshold amount of the ghosting artifact will be displayed outside of the display's FOV, then service 105 can avoid further action.

The threshold amount can be set to any value. For instance, if service 105 determines that 90% of the ghosting artifact will not be included in the display's FOV, then service 105 can determine that no further action is warranted to suppress the visibility of the ghosting artifact. As another example, if service 105 determines that 80% of the ghosting artifact will not be included in the display's FOV, then service 105 can determine that no further action is warranted to suppress the visibility of the ghosting artifact. As another example, if service 105 determines that 50% of the ghosting artifact will not be included in the display's FOV, then service 105 can determine that no further action is warranted to suppress the visibility of the ghosting artifact. As another example, if service 105 determines that 25% of the ghosting artifact will not be included in the display's FOV, then service 105 can determine that no further action is warranted to suppress the visibility of the ghosting artifact. As another example, if service 105 determines that 5% of the ghosting artifact will not be included in the display's FOV, then service 105 can determine that no further action is warranted to suppress the visibility of the ghosting artifact. Thus, any threshold percentage can be used, such as any value between 1% and 99%. Often, the threshold is set to at least 50%. Thus, if at least 50% of the ghost artifact will not be displayed by the display, then service 105 can avoid taking further action.

In some scenarios, service 105 can base its decision on the number of pixels that will be visible within the display's FOV. For instance, if a threshold number of pixels will be visible, then service 105 might take the subsequent corrective actions described later. On the other hand, if the threshold number of pixels will not be visible, then service 105 can determine that no further action is warranted. As a specific example, if less than 100 pixels of the ghost artifact will be visible, then service 105 can choose to avoid further action. As another example, if less than 200, 300, 400, 500, 1,000 or any predetermined number of pixels will be visible, then service 105 can choose to avoid further action. On the other hand, if more than a preestablished threshold number of pixels for the ghost artifact will be visible, then service 105 can choose to take subsequent action. Thus, some embodiments determine whether to act based on the number of pixels that will be visible for the ghost artifact or based on the percentage of the ghost artifact that will be visible.

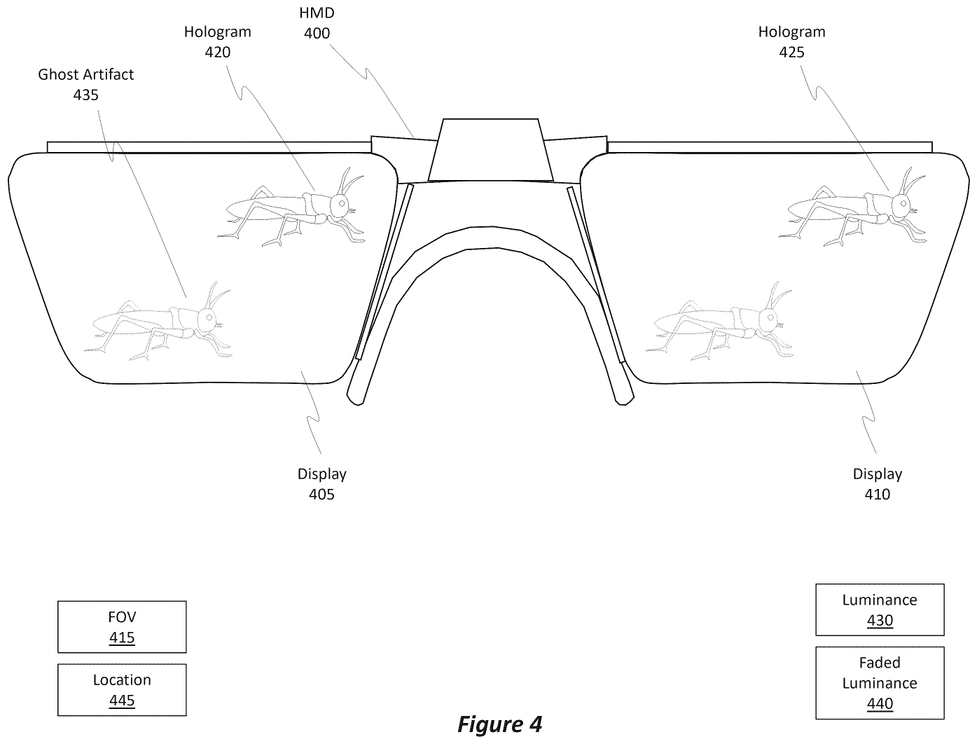

It should be noted how service 105 can make the above determinations either before or after the scene image 125 is obtained. Thus, in a first scenario, service 105 first determines the attributes of the ghosting artifact and whether further actions are warranted. If further actions are warranted, service 105 can then obtain the scene image 125. In a second scenario, service 105 can first obtain the scene image 125 and then perform the above determinations. In a third scenario, service 105 can concurrently, simultaneously, in parallel, or in some overlapping manner perform the above determinations with the process of obtaining the scene image 125. Often, the determinations of whether to proceed are performed first because, if no further action is warranted, compute expenses can be saved by avoiding the process of obtaining the scene image 125. FIG. 4 provides additional details regarding the ghosting artifact.

FIG. 4 shows an example HMD 400 that is representative of ER system 110 of FIG. 1. HMD 400 includes a first display 405 and a second display 410. The first and second displays 405 and 410 have corresponding FOVs, as shown by FOV 415.

FIG. 4 shows a hologram 420 being displayed in display 405 and a corresponding hologram 425 being displayed in display 410. For the remainder of this disclosure, the principles will be described with respect to a single one of the displays, but a person skilled in the art will recognize how these principles are applicable and will be applied to both of the displays.

Hologram 420 is displayed in display 405 as having a particular luminance 430 and a color or color combination. FIG. 4 also shows the resulting ghost artifact 435 of hologram 420 in display 405. In some scenarios (not illustrated in the Figures), the type of ghost that is created (i.e. one that is caused by a back reflection from the display unit), the ghost will be upside down and flipped left to right relative to the hologram. Other types of ghosts (such as the one depicted in the Figures) may not be caused by the same mechanism and will not be upside down. Thus, the disclosed Figures should be interpreted in a broad manner, and a person skilled in the art should understand how the depiction of the ghost may be different depending on the circumstances that caused the ghost to be created. The ghosts in the Figures are provided for simple demonstration purposes only and should not be viewed as being an exact depiction of how ghosts are visualized.

Notice, ghost artifact 435 has a faded luminance 440 relative to the luminance 430 of hologram 420. By “faded,” it is meant that the luminance characteristics of the ghost artifact 435 are dimmed, dulled, diminished, reduced, lowered, or not as vibrant as the luminance characteristics of the hologram 420. Often, the luminance characteristics of the ghost artifact 435 are less than about 10% of the luminance characteristics of the hologram 420. In some scenarios, the luminance of the ghost artifact 435 can be 1% or even less than 1% of the luminance of the hologram 420. Ghost artifact 435 is also displayed at a determined location 445 relative to the hologram 420 in display 405. As mentioned previously, this location can be determined in a variety of ways. Typically, the location of the ghost artifact 435 is at least partially dependent on the location of the hologram 420. Thus, as the hologram 420 moves, so too does the ghost artifact 435.

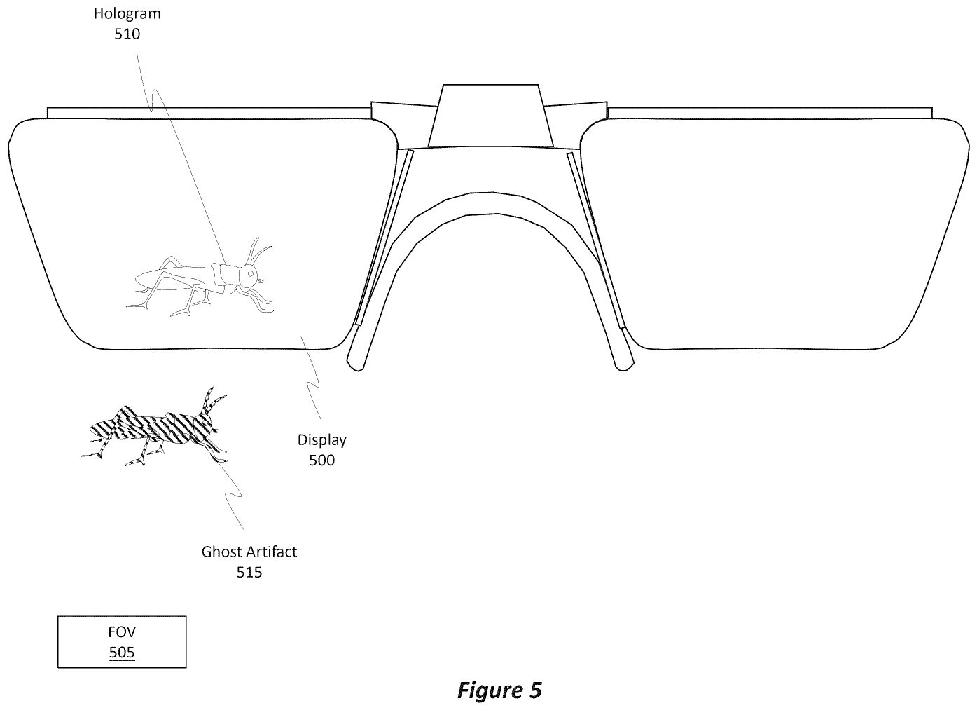

As shown in FIG. 5, in some scenarios, the location of the ghost artifact will be outside of the FOV of the display and thus the ghost artifact will not be visible to the user. For instance, FIG. 5 shows a display 500 having a given FOV 505. Display 500 is displaying a hologram 510. The ghost artifact 515 for hologram 510 is outside of the FOV 505 of display 500 such that the ghost artifact 515 will not be visible to the user. In such scenarios, service 105 of FIG. 1 can determine that no further action is warranted because the ghost artifact 515 will not disturb the user because it is not visible. As mentioned previously, if a portion of the ghost artifact 515 will be visible, service 105 can intelligently determine whether or not to take subsequent action based on the relative visibility of that portion.

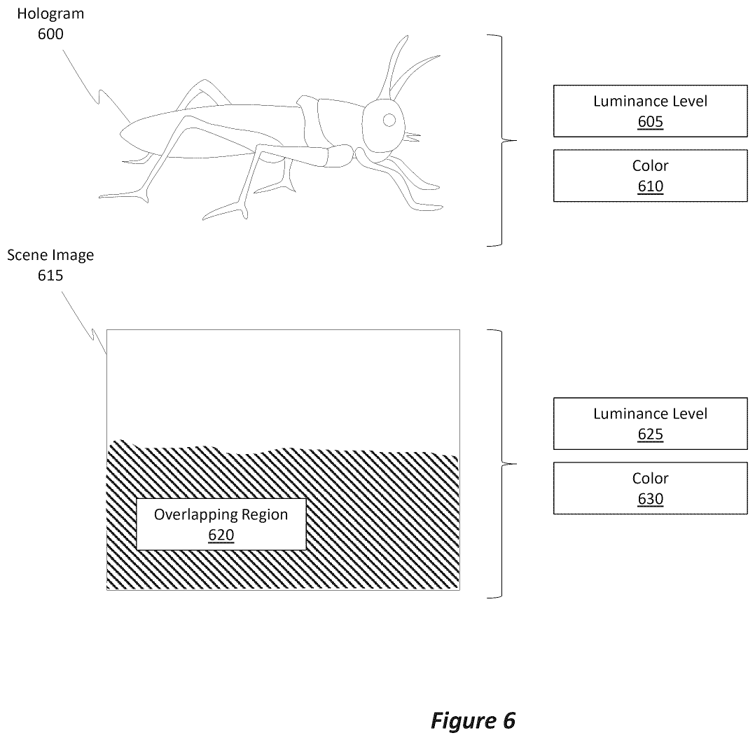

When, however, the ghost artifact will be visible to the user (at least by a threshold amount, as discussed earlier), service 105 can take further action. Specifically, service 105 of FIG. 1 determines the location 130 of the ghost artifact on the display's FOV, the overlapping location 135 of the ghost artifact relative to the scene image 125, the luminance 140 of both the ghost artifact and the portion of the scene where the ghost artifact overlaps, and the contrast 145 between those two luminances. FIG. 6 provides additional details.

FIG. 6 shows a hologram 600 that is representative of any of the holograms discussed thus far. Service 105 of FIG. 1 is able to determine the luminance level 605 of the hologram 600 as well as the color 610. The color 610 might be a single color or it might be a combination of multiple colors. Thus, reference to “color” includes scenarios involving a single color and a combination of multiple colors.

Determining the luminance level 605 and the color 610 of the hologram enables service 105 to also determine the luminance and color of the resulting ghost artifact. As mentioned previously, the ghost artifact will be a significantly faded version of the hologram 600. Thus, the luminance of the ghost artifact will be a determined percentage of the luminance level 605 of the actual hologram 600. The color of the ghost artifact will also correspond to the color 610.

Service 105 is able to calculate the faded characteristics of the ghost artifact in a computational manner, determine the characteristics based on an analysis of an image of the display, or make a prediction based on historical data. For instance, service 105 can calculate what the faded properties will be based on the optical characteristics of the ER system. Additionally or alternatively, service 105 can obtain an image of the display and analyze the characteristics of the ghost artifact in that image. Additionally or alternatively, service 105 can collect historical data of faded properties of holograms to determine how much fading will occur with respect to a ghost artifact. The ML engine 115 of FIG. 1 can be trained and can use machine intelligence to make a prediction on the faded characteristics. Thus, the characteristics of the hologram 600 can be used to determine the characteristics of the ghost artifact. As mentioned previously, it is typically the case that the luminance of the ghost artifact is less than about 10% that of the luminance of the actual hologram. Thus, if the hologram has a luminance intensity for a given color of 87%, the luminance intensity of the ghost artifact will be less than about 8.7% for that given color. Often, the luminance of the ghost artifact is around 1% that of the luminance of the hologram. Thus, using the above example, the luminance intensity of the ghost artifact will be about 0.87% plus or minus a given buffer or threshold.

Service 105 is also able to determine where, within the scene image 615 (which corresponds to scene image 125 of FIG. 1), the ghost artifact will overlap. That is, although the ER system will not display the scene image 615, the embodiments are able to use the scene image 615 to determine where the ghost artifact will be displayed with respect to the objects in the scene. This determination is beneficial because it enables the embodiments to intelligently modify the luminance of the actual hologram so that the resulting luminance of the ghost artifact is low enough that the ghost artifact will effectively blend in with the background of the scene. Further details are provided shortly.

In FIG. 6, service 105 determines the ghost artifact of hologram 600 will overlap the pixels shown by overlapping region 620. Determining the overlap region 620 is based on the positional determinations made and discussed previously. Some embodiments identify a box-like shape where the ghost artifact will be and use the pixels in the box. Other embodiments carve out the specific outline of the ghost artifact and use the pixels included within the customized shape.

Service 105 then determines the characteristics of the pixels for the overlapping region 620 of scene image 615. These pixel characteristics include those pixels' luminance levels (e.g., as shown by luminance level 625) and those pixels' color (e.g., as shown by color 630). One or more colors may be present. The characteristics of each pixel in the selected region can be determined.

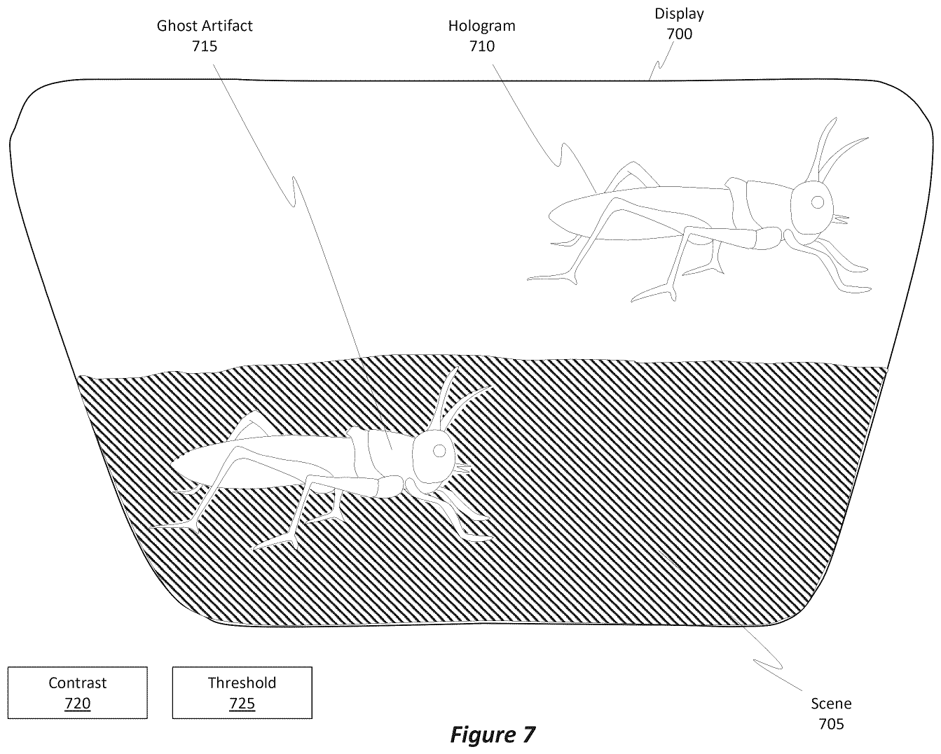

FIG. 7 shows a display 700 of an HMD. Display 700 is a type of passthrough display in which a portion of the environment is visible, as shown by scene 705. Display 700 also shows a hologram 710 and a ghost artifact 715 of the hologram 710. As mentioned previously, service 105 determines the luminance and color characteristics of both the hologram 710 and the scene 705. Service 105 uses the luminance and color characteristics of the hologram 710 to determine corresponding characteristics of the ghost artifact 715. Service 105 further determines the luminance and color characteristics of the pixels in the scene image where the ghost artifact 715 will overlap.

Using that data, service 105 can then determine the contrast 720 between the ghost artifact 715 and the pixels in the scene image where the ghost artifact 715 overlaps. If this contrast 720 exceeds a predetermined threshold 725, then service 105 will determine that the ghost artifact 715 will likely be a disturbance for the user and a corrective action is warranted. To illustrate, in FIG. 7, the contrast 720 exceeds the threshold 725, and the ghost artifact 715 is quite visible for the user.

Often, the ghost artifact 715 will not be a uniform color or luminance, and the background pixels of the scene in the overlapping region will also not be a uniform color or luminance. In such scenarios, the embodiments can compute an average contrast for the entire ghost artifact and compare that average contrast to the threshold. In some scenarios, the ghost artifact can be segmented, and different contrasts and threshold can be applied to each segment. If a threshold number of segment contrasts exceed the segment thresholds, then mitigation is warranted; otherwise, no mitigation might be warranted.

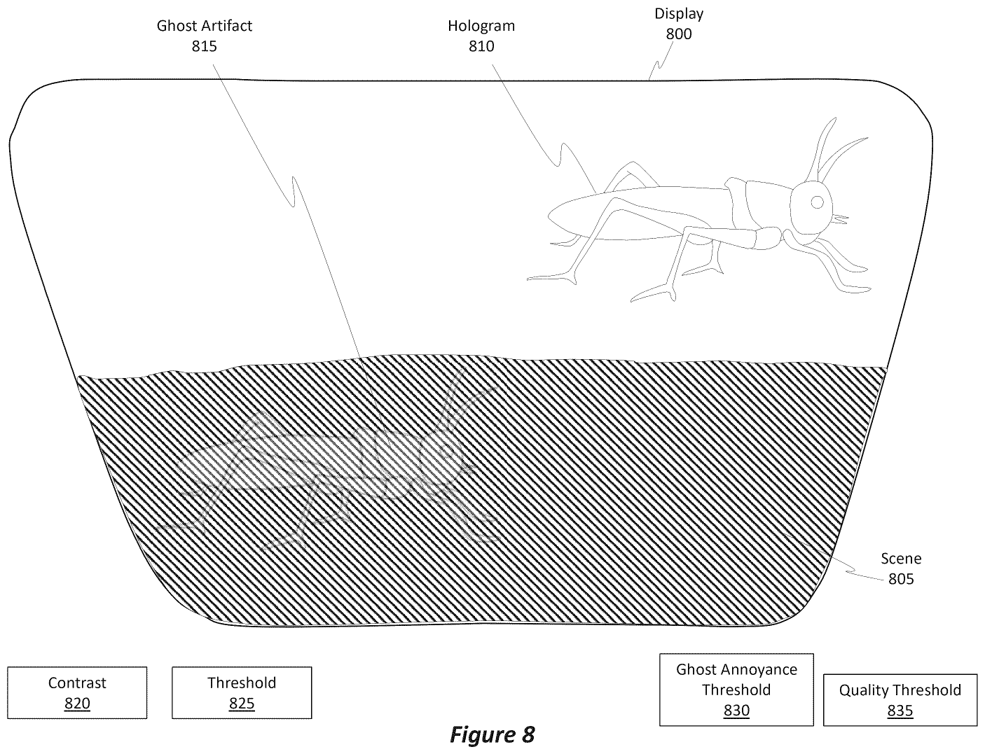

In response to service 105 determining that the contrast 720 exceeds the threshold 725, service 105 can then intelligently reduce the display characteristics of the hologram 710, such as by reducing the luminance of the hologram 710. By reducing the luminance of the hologram 710, the resulting contrast 720 of the ghost artifact 715 will also be reduced. Service 105 can reduce the luminance a sufficient amount so that the resulting contrast 720 is at or below the threshold 725. In doing so, service 105 can cause the ghost artifact 715 to effectively merge with or be hidden by the scene 705. FIG. 8 is illustrative.

FIG. 8 shows a display 800, a scene 805, a hologram 810, and a ghost artifact 815. In this scenario, service 105 has reduced the luminance of the hologram 810 by a determined amount so as to cause the resulting contrast 820 between the ghost artifact 815 and the background scene 805 to be at or below the threshold 825. As a result, ghost artifact 815 is now shown as effectively merging with or being hidden by the scene 805.

By performing these operations, the embodiments beneficially improve the quality of the image by hiding the effects of the ghost artifact 815. Although the ghost artifact 815 may still be present, its visibility is reduced to a level such that the ghost artifact 815 either is no longer substantially visible or is at a level such that the ghost artifact 815 does not disturb or distract the user.

In some scenarios, service 105 may impose a ghost annoyance threshold 830 to the amount of reduction that is permitted with respect to the hologram's luminance. For instance, if the hologram's luminance is reduced too much, then the quality of the hologram 810 might not achieve a quality threshold 835.

As a result, service 105 can impose a maximum amount of luminance reduction that is permitted, where this maximum amount of reduction is viewed as being the ghost annoyance threshold 830. It might be the case that this ghost annoyance threshold 830 is reached, yet the ghost artifact is still visible. This is a tradeoff that is often permitted because it is more desirable to sufficiently maintain the quality of the hologram 810 (at least to the quality threshold 835). Even then, the visibility of the ghost artifact 815 will still be reduced. Thus, although the ghost artifact 815 might still be visible when the ghost annoyance threshold 830 is followed, the impact of the ghost artifact 815 will be significantly reduced and the ghost artifact 815 will likely not substantially distract the user.

As mentioned previously, service 105 can perform the above operations before or after a hologram is displayed. Thus, the operations can be reactive in response to a ghost artifact actually being displayed, or the operations can be proactive and can occur prior to the ghost artifact actually being displayed. If proactive, service 105 can determine or predict all of the characteristics that are involved, including the amount of luminance reduction that may be needed. In some cases, the initial prediction may be implemented, but further reduction may be warranted (e.g., based on an analysis of an image of the display in which the ghost artifact is still visible). In such a scenario, service 105 can then facilitate further reductions to the hologram's luminance.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

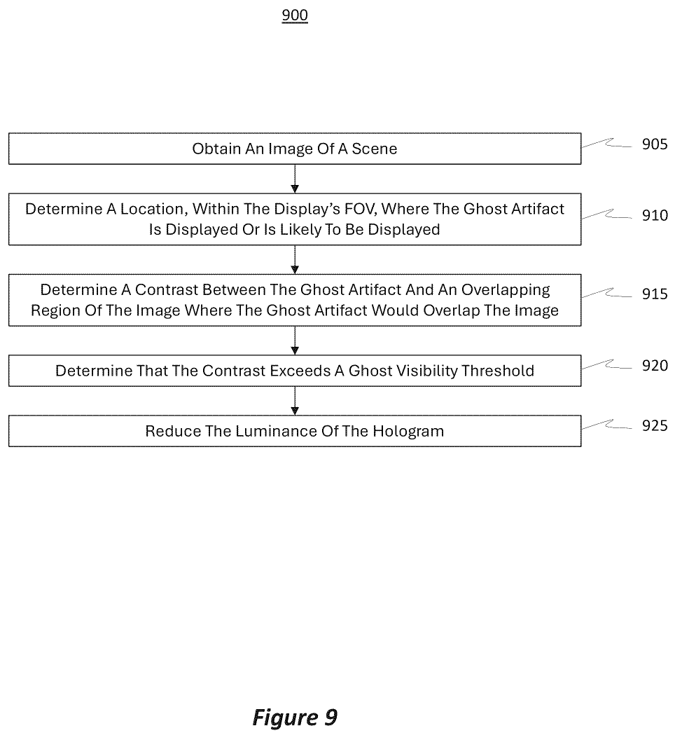

Attention will now be directed to FIG. 9, which illustrates a flowchart of an example method 900 for correcting a ghost artifact of a hologram that is displayed by an extended reality (ER) system, where the ghost artifact of the hologram occurs as a result of display light for the hologram back-reflecting off of one or more optical elements of the ER system, resulting in generation of the ghost artifact, and where the ghost artifact has a faded luminance relative to a luminance of the hologram. Method 900 can be performed within architecture 100 of FIG. 1 and by the ER system 110. Additionally, method 900 can be performed by service 105, which may be executing on ER system 110 or in the cloud 120.

Method 900 includes an act (act 905) of obtaining an image of a scene in which the ER system is operating. For example, the scene image 125 of FIG. 1 can be representative of this image. Notably, a region of the image portrays at least some and perhaps an entirety of a field of view (FOV) of a display of the ER system. For instance, with respect to FIG. 3, camera 315 can capture an image, and the image may reflect the entirety of the FOV of the display over which camera 315 is positioned. In some scenarios, some, but not all, of the display's FOV is captured by the image. Typically, however, the entirety of the display's FOV is reflected within the image. In some cases, a majority of the display's FOV is reflected within the image, such as any percentage that is 51% or more. In some scenarios, the display might be a foveated display. In such scenarios, at least the foveated display region is captured by the image.

Often, the faded luminance of the ghost artifact is predetermined to be 5% or less of the luminance of the hologram. The faded luminance of the ghost artifact can be predetermined to be 2% or less of the luminance of the hologram. The faded luminance of the ghost artifact can be approximately 1% of the luminance of the hologram. It should be noted how the faded luminance can be anywhere above 0% up to about 10% of the luminance of the hologram.

Act 910 includes determining a location, within the display's FOV, where the ghost artifact is displayed or is likely to be displayed. For instance, with respect to FIG. 4, the embodiments are able to determine the location of the hologram 420. Based on that location, the embodiments can also determine the location of the ghost artifact 435.

Optionally, the display may be a first display of the ER system. Optionally, the ER system can include a second display. The display can be a passthrough display such at least a portion of the scene and the hologram are simultaneously visible through the display. Also, the location where the ghost artifact is displayed can be determined based on an identified location in the display where the hologram is displayed. Thus, as the hologram moves, so too does the ghost artifact.

Act 915 includes determining a contrast between the ghost artifact and an overlapping region of the image where the ghost artifact would overlap the image based on an alignment between (i) the image and (ii) the location in the display's FOV where the ghost artifact is displayed or is likely to be displayed. For instance, with respect to FIGS. 6 and 7, the embodiments can determine that a ghost artifact of hologram 600 will be displayed at the overlapping region 620 of the scene image 615. Then, as shown in FIG. 7, the embodiments can determine the contrast 720 between the ghost artifact 715 and the pixels of the scene that are behind the ghost artifact 715 (as those pixels are reflected in the scene image). Notably, the image of the background scene is likely not displayed by the ER system, but the ER system is using the image of the background scene to determine the contrast between the ghost artifact and the pixels of the overlapping region.

In some scenarios, act 915 can include determining, for each of at least some pixels in the overlapping region of the image, a corresponding luminance level and a corresponding color. Also, the process of determining the contrast between the ghost artifact and the overlapping region can be based on a determined contrast between (i) the luminance levels and the colors for the pixels in the overlapping region and (ii) luminance levels and colors of the ghost artifact.

Act 920 then includes determining that the contrast exceeds a ghost visibility threshold. The threshold 725 of FIG. 7 is representative of this ghost visibility threshold.

Act 925 then includes reducing the luminance of the hologram, resulting in the contrast between the ghost artifact and the overlapping region of the image falling below the ghost visibility threshold and further resulting in the ghost artifact substantially visually merging with the scene. FIG. 8 shows how, as a result of reducing the luminance of the hologram 810, the visibility of the ghost artifact 815 falls below the threshold 825, effectively causing the ghost artifact 815 to be hidden among or within (i.e. merged with) the background of the scene.

In some scenarios, reducing the luminance of the hologram is prevented from being reduced below a ghost annoyance threshold, such as the ghost annoyance threshold 830 of FIG. 8. Reductions of the hologram's luminance below the ghost annoyance threshold would cause a display quality of the hologram to fall below a quality threshold (e.g., quality threshold 835).

In some scenarios, the reductions occur in response to detected color attributes of the hologram. For instance, red and green colors are typically much more visible to the human eye than blue colors (or at least much more noticeable, leading to higher distraction on the part of the user). Thus, the above operations can be performed if red and green colors are detected. The above operations can either be refrained from being performed or can be performed at a reduced rate if blue colors are identified. For instance, some embodiments determine that a color of the hologram includes at least one of a red hue/color or a green hue/color. As used herein, “hue” and “color” can be used interchangeably. The process of reducing the luminance of the hologram can thus be performed by reducing one or both of the red hue or the green hue while refraining from reducing a blue hue of the hologram (or perhaps by reducing the blue hue less than reductions made to the red or green hues).

By way of further detail, reducing the luminance of the hologram can occur in response to a determination that a color of the hologram includes one or both of a red hue or a green hue. In some implementations, reducing the luminance of the hologram occurs in response to a determination that a color of the hologram either (i) omits a blue hue or (ii) has a level of the blue hue below a blue color threshold (e.g., a threshold amount of the hologram or ghost artifact is of the blue color). In some scenarios, reducing the luminance of the hologram occurs in response to a determination that a color of the hologram omits a blue hue. In some scenarios, reducing the luminance of the hologram occurs in response to a determination that a color of the hologram has a level of a blue hue that is below a blue hue threshold. Thus, different colors can be subjected to different amounts of reductions due to differences in how human users perceive those colors.

In some embodiments, the determined location of the ghost artifact is a “predicted” location as a result of the hologram not yet being displayed. Also, the determined contrast between the ghost artifact and the overlapping region can be a “predicted” contrast as a result of the hologram not yet being displayed. Furthermore, the luminance of the hologram can be an “anticipated” or “predicted” luminance as a result of the hologram not yet being displayed. The hologram can be subsequently displayed at the anticipated luminance.

Optionally, the hologram can include a combination of multiple different colors. The process of reducing the luminance of the hologram can include reducing a corresponding luminance for each color in the combination of multiple different colors by a same amount. Alternatively, reducing the luminance of the hologram includes reducing a first luminance for a first one of the colors by a first amount and reducing a second luminance for a second one of the colors by a second, different amount. For instance, if the hologram has primarily a red hue but it also has a faint green hue, the embodiments can reduce the red hue by a larger amount than the green hue. Intelligence can be employed to determine the relative amount of reductions between the different colors so as to not impair the quality of the image or the generalized color relationship of the hologram.

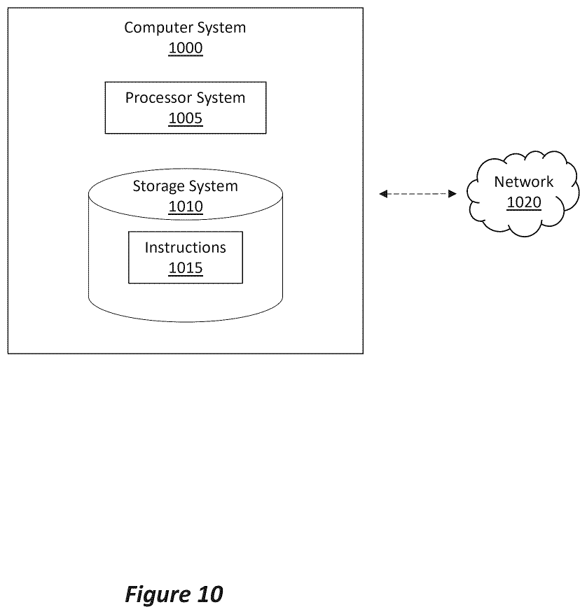

Attention will now be directed to FIG. 10 which illustrates an example computer system 1000 that may include and/or be used to perform any of the operations described herein. For instance, computer system can implement service 105 of FIG. 1. Computer system can also take the form of ER system 110.

Computer system 1000 may take various different forms. For example, computer system 1000 may be embodied as a tablet, a desktop, a laptop, a mobile device, or a standalone device, such as those described throughout this disclosure. Computer system 1000 may also be a distributed system that includes one or more connected computing components/devices that are in communication with computer system 1000.

In its most basic configuration, computer system 1000 includes various different components. FIG. 10 shows that computer system 1000 includes a processor system 1005, which may include one or more processor(s) (aka a “hardware processing unit”) and a storage system 1010.

Regarding the processor(s) of processor system 1005, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1000. The different components, modules, engines, and services described herein may be implemented as objects or processors that execute on computer system 1000 (e.g. as separate threads).

Storage system 1010 may be physical system memory, which may be volatile, non-volatile, or some combination of the two. The term “memory” may also be used herein to refer to non-volatile mass storage such as physical storage media. If computer system 1000 is distributed, the processing, memory, and/or storage capability may be distributed as well.

Storage system 1010 is shown as including executable instructions 1015. The executable instructions 1015 represent instructions that are executable by the processor(s) of processor system 1005 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1000 may also be connected (via a wired or wireless connection) to external sensors (e.g., one or more remote cameras) or devices via a network 1020. For example, computer system 1000 can communicate with any number devices or cloud services to obtain or process data. In some cases, network 1020 may itself be a cloud network. Furthermore, computer system 1000 may also be connected through one or more wired or wireless networks to remote/separate computer systems(s) that are configured to perform any of the processing described with regard to computer system 1000.

A “network,” like network 1020, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1000 will include one or more communication channels that are used to communicate with the network 1020. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for correcting a ghost artifact of a hologram that is displayed by an extended reality (ER) system, where the ghost artifact of the hologram occurs as a result of display light for the hologram back-reflecting off of one or more optical elements of the ER system, resulting in generation of the ghost artifact, and where the ghost artifact has a faded luminance relative to a luminance of the hologram, said method comprising:
obtaining an image of a scene in which the ER system is operating, wherein a region of the image portrays at least some of a field of view (FOV) of a display of the ER system;
determining a location, within the display's FOV, where the ghost artifact is displayed or is likely to be displayed;
determining a contrast between the ghost artifact and an overlapping region of the image where the ghost artifact would overlap the image based on an alignment between (i) the image and (ii) the location in the display's FOV where the ghost artifact is displayed or is likely to be displayed;
determining that the contrast exceeds a ghost visibility threshold; and
reducing the luminance of the hologram, resulting in the contrast between the ghost artifact and the overlapping region of the image falling below the ghost visibility threshold and further resulting in the ghost artifact substantially visually merging with the scene.

2. The method of claim 1, wherein the method further includes:
for each of at least some pixels in the overlapping region of the image, determining a corresponding luminance level and a corresponding color.

3. The method of claim 2, wherein determining the contrast between the ghost artifact and the overlapping region is based on a determined contrast between (i) the luminance levels and the colors for said at least some pixels in the overlapping region and (ii) luminance levels and colors of the ghost artifact.

4. The method of claim 1, wherein reducing the luminance of the hologram is prevented from being reduced below a ghost annoyance threshold, and wherein reductions of the hologram's luminance below the ghost annoyance threshold would cause a display quality of the hologram to fall below a quality threshold.

5. The method of claim 1, wherein the method further includes:
determining that a color of the hologram includes at least one of a red color or a green color; and
reducing the luminance of the hologram by reducing one or both of the red color or the green color while refraining from reducing a blue color of the hologram.

6. The method of claim 1, wherein reducing the luminance of the hologram occurs in response to a determination that a color of the hologram includes one or both of a red color or a green color.

7. The method of claim 1, wherein reducing the luminance of the hologram occurs in response to a determination that a color of the hologram either (i) omits a blue color or (ii) has a level of the blue color below a blue color threshold.

8. The method of claim 1, wherein the display is a first display of the ER system, and wherein the ER system includes a second display.

9. The method of claim 1, wherein the location where the ghost artifact is displayed is determined based on an identified location in the display where the hologram is displayed.

10. The method of claim 1, wherein the faded luminance of the ghost artifact is predetermined to be 5% or less of the luminance of the hologram.

11. The method of claim 10, wherein the faded luminance of the ghost artifact is predetermined to be 2% or less of the luminance of the hologram.

12. A computer system that corrects a ghost artifact of a hologram that is displayed by the computer system, where the ghost artifact of the hologram occurs as a result of display light for the hologram back-reflecting off of one or more optical elements of the computer system, resulting in generation of the ghost artifact, and where the ghost artifact has a faded luminance relative to a luminance of the hologram, said computer system comprising:
a processor system; and
a storage system that stores instructions that are executable by the processor system to cause the computer system to:
obtain an image of a scene in which the computer system is operating, wherein a region of the image portrays at least some of a field of view (FOV) of a display of the computer system;
determine a location, within the display's FOV, where the ghost artifact is displayed or is likely to be displayed;
determine a contrast between the ghost artifact and an overlapping region of the image where the ghost artifact would overlap the image based on an alignment between (i) the image and (ii) the location in the display's FOV where the ghost artifact is displayed or is likely to be displayed;
determine that the contrast exceeds a ghost visibility threshold; and
reduce the luminance of the hologram, resulting in the contrast between the ghost artifact and the overlapping region of the image falling below the ghost visibility threshold and further resulting in the ghost artifact substantially visually merging with the scene.

13. The computer system of claim 12, wherein the display is a passthrough display such at least a portion of the scene and the hologram are simultaneously visible through the display.

14. The computer system of claim 12, wherein:
the determined location of the ghost artifact is a predicted location as a result of the hologram not yet being displayed;
the determined contrast between the ghost artifact and the overlapping region is a predicted contrast as a result of the hologram not yet being displayed,
the luminance of the hologram is an anticipated luminance as a result of the hologram not yet being displayed, and
the hologram is subsequently displayed at the anticipated luminance.

15. The computer system of claim 12, wherein the faded luminance of the ghost artifact is approximately 1% of the luminance of the hologram.

16. The computer system of claim 12, wherein reducing the luminance of the hologram occurs in response to a determination that a color of the hologram omits a blue hue.

17. The computer system of claim 12, wherein reducing the luminance of the hologram occurs in response to a determination that a color of the hologram has a level of a blue hue that is below a blue color threshold.

18. The computer system of claim 12, wherein:
the hologram includes a combination of multiple different colors, and
reducing the luminance of the hologram includes reducing a corresponding luminance for each color in the combination of multiple different colors by a same amount.

19. The computer system of claim 12, wherein:
the hologram includes a combination of multiple different colors, and
reducing the luminance of the hologram includes reducing a first luminance for a first one of the colors by a first amount and reducing a second luminance for a second one of the colors by a second, different amount.

20. An extended reality (ER) system that corrects a ghost artifact of a hologram that is displayed by the ER system, where the ghost artifact of the hologram occurs as a result of display light for the hologram back-reflecting off of one or more optical elements of the ER system, resulting in generation of the ghost artifact, and where the ghost artifact has a faded luminance relative to a luminance of the hologram, said ER system comprising:
a processor system; and
a storage system that stores instructions that are executable by the processor system to cause the ER system to:
obtain an image of a scene in which the ER system is operating, wherein a region of the image portrays at least some of a field of view (FOV) of a display of the ER system;
determine a location, within the display's FOV, where the ghost artifact is displayed or is likely to be displayed;
determine a contrast between the ghost artifact and an overlapping region of the image where the ghost artifact would overlap the image based on an alignment between (i) the image and (ii) the location in the display's FOV where the ghost artifact is displayed or is likely to be displayed;
determine that the contrast exceeds a ghost visibility threshold; and
reduce the luminance of the hologram, resulting in the contrast between the ghost artifact and the overlapping region of the image falling below the ghost visibility threshold and further resulting in the ghost artifact substantially visually merging with the scene.
